(19) United States
(12) Patent Application Publication
(10) Pub. No.: US 2018/0050812 A1
(43) Pub. Date: Feb. 22, 2018

(54) AIRCRAFT FUEL PUMP SYSTEMS

(71) Applicant: Hamilton Sundstrand Corporation, Charlotte, NC (US)

(72) Inventors: Lubomir A. Ribarov, West Hartford, CT (US); Leo J. Veilleux, JR., Wethersfield, CT (US)

(21) Appl. No.: 15/237,905

(22) Filed: Aug. 16, 2016

(51) Int. Cl. B64D 37/14; F02C 7/236

(52) U.S. Cl. CPC B64D 37/14; F05D 2220/323; F02C 7/236

(57) ABSTRACT

An aircraft fuel system includes a first pump system that is mechanically driven and in selective fluid communication with a fuel tank and a fuel nozzle of an engine. The first pump system is configured to pump fuel to the fuel nozzles in a high flow rate condition and to be starved or nearly starved of fuel in a low flow rate condition. The aircraft fuel system includes a second pump system including an electric motor. The second pump system is in fluid communication with the fuel tank and the fuel nozzle to pump fuel from the fuel tank to the fuel nozzles. The second pump system is driven by the electric motor and is configured to pump flow in both the high flow rate condition and the low flow rate condition.

### BACKGROUND

### 1. Field

The present disclosure relates to fuel pumps, more specifically to aircraft fuel pump systems.

### 2. Description of Related Art

Aircraft gas turbine engines receive pressurized fuel from fuel gear pumps. The gear pump must be compact, light-weight, and robust. The gear pump must perform over a wide operational range while providing critical fuel flows and pressures for various engine performance functions. Typically these gear pumps receive rotational power from an accessory gearbox through an input drive shaft. These gear fuel pumps are often oversized in order to satisfy the high-flow, high pressure fuel flow requirements at take-off engine power and/or low-speed windmill starts/re-starts. Subsequently, during the climb and cruise phases of the flight, the fuel flow to the engine is much reduced resulting in unnecessary additional pump power that remains unused.

The current practice includes bypassing a significant portion of the pressurized fuel flow past the fuel nozzles and back into the main fuel tanks. This is undesirable from a thermal management perspective and is a waste of energy. This bypassing increases the temperature of the fuel and limits the capability of fuel to be a heat sink. This fuel bypassing also wears out the fuel pumps, thus shortening their operational life, and introduces possible gas (air, oxygen, nitrogen, etc.) entrainment into the fuel. This is undesirable from an operational perspective.

Such conventional methods and systems have generally been considered satisfactory for their intended purpose. However, there is still a need in the art for improved aircraft fuel pump systems. The present disclosure provides a solution for this need.

### SUMMARY

An aircraft fuel system includes a first pump system that is mechanically driven and it is in selective fluid communication with a fuel tank and one or more fuel nozzles of an engine. The first pump system is configured to pump fuel to the one or more fuel nozzles in a high flow rate condition and to be starved or nearly starved of fuel in a low flow rate condition. The aircraft fuel system includes a second pump system including an electric motor. The second pump system is in fluid communication with the fuel tank and the one or more fuel nozzles to pump fuel from the fuel tank to the one or more fuel nozzles. The second pump system is driven by the electric motor and is configured to pump flow in both the high-flow rate condition and the low-flow rate condition.

The second pump system can include a total-flow pump and a main pump attached to the electric motor, wherein the total-flow pump is configured to boost the main pump and/or the mechanically driven first pump system. The aircraft fuel system can include a first valve configured to shut-off or otherwise limit fuel flow to the first pump system, the first valve positioned between the total-flow pump and the first pump system.

The aircraft fuel system can include a heat exchanger disposed between the first pump system and the second pump system. The heat exchanger can be a fuel-oil heat exchanger, for example, that is configured to cool engine oil with the fuel in the aircraft fuel system.

The aircraft fuel system can include an ejector pump disposed between the first pump system and the second pump system and configured to evacuate the first pump system in the low fuel flow condition. The ejector pump can include a venturi, for example.

The aircraft fuel system can include a system shut-off valve disposed upstream of the fuel nozzle and downstream of the first and second pump systems. The aircraft fuel system can include a throttle valve disposed between the first pump system and the fuel nozzle.

The aircraft fuel system can include a controller operatively connected to the electric motor and to one or more sensors disposed in the aircraft fuel system to control the electric motor as a function of output of the one or more sensors. The controller can be operatively connected to one or more valves of the aircraft fuel system to actuate the valves as a function of the output of the one or more sensors. The one or more sensors can include at least one of a flow meter disposed upstream of the fuel nozzle, a pressure sensor disposed downstream of the first pump system, or a pressure sensor disposed downstream of the fuel nozzle.

The main pump can include one of a vane pump or gear pump. The second pump system can include a cruise pump, wherein the cruise pump is configured to boost the main pump. The first pump system can include a take-off pump. The total-flow pump, the cruise pump, or the take-off pump can include a centrifugal pump.

The aircraft fuel system can include a first heat exchanger disposed between the total-flow pump and the first pump system and a second heat exchanger disposed between the cruise pump and the main pump. The aircraft fuel system can include a system shut-off valve disposed upstream of the first and second pump systems.

A method includes adjusting volume of fuel pumped to one or more fuel nozzles in response to a change in fuel demand of an engine.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic view of an embodiment of a system in accordance with this disclosure;

FIG. 2 is a schematic view of the system of FIG. 1, shown in low flow mode, e.g., for cruise and/or startup operations with lower fuel consumption requirements;

FIG. 3 is a schematic view of the system of FIG. 1, shown in high flow mode, e.g., for take-off or other modes with higher fuel consumption requirements; and

FIG. 4 is a schematic view of another embodiment of a system in accordance with this disclosure.

### DETAILED DESCRIPTION

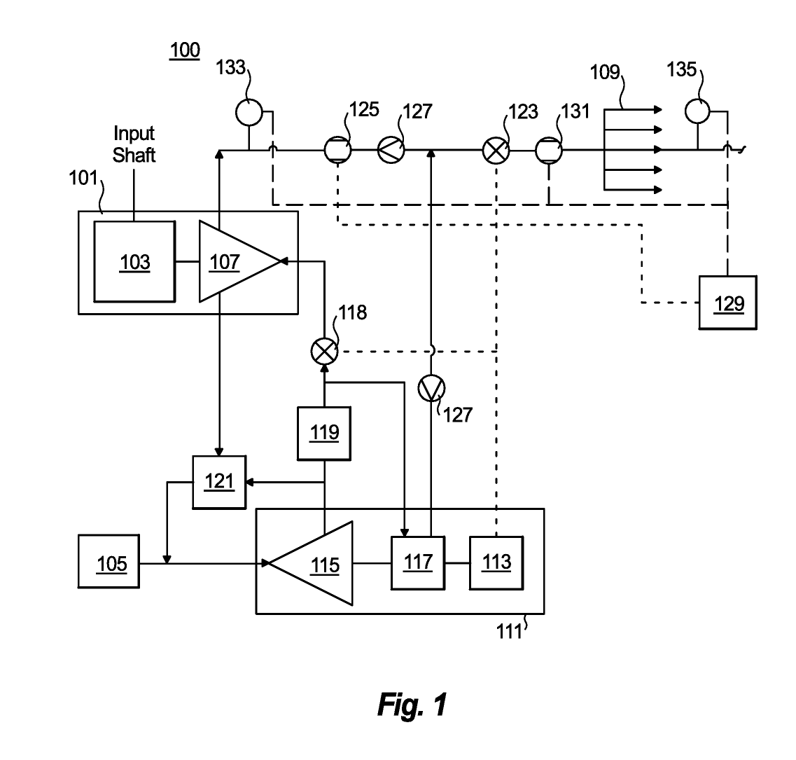

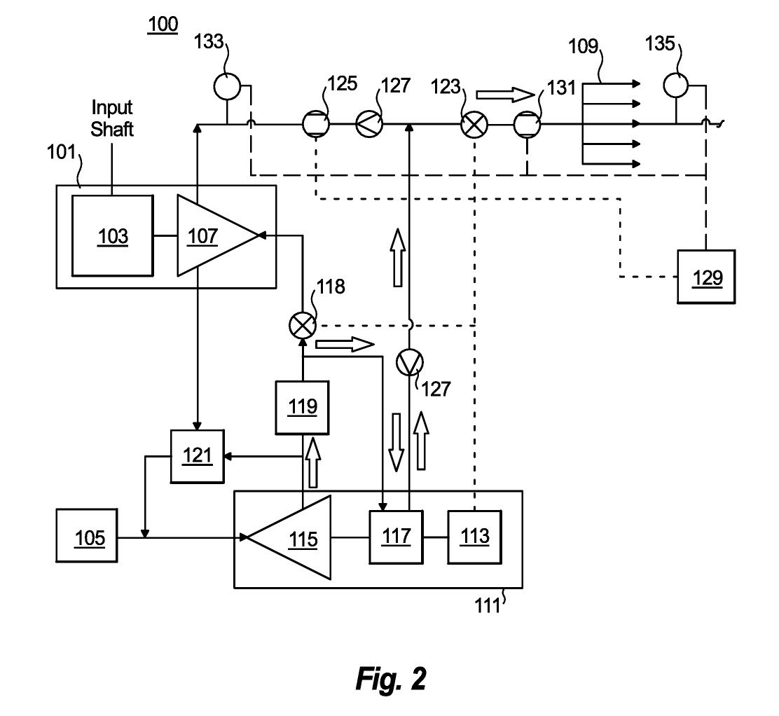

Reference will now be made to the drawings wherein like reference numerals identify similar structural features or aspects of the subject disclosure. For purposes of explanation and illustration, and not limitation, an illustrative view of an embodiment of an aircraft fuel system in accordance with the disclosure is shown in FIG. 1 and is designated generally by reference character 100. Other embodiments and/or aspects of this disclosure are shown in FIGS. 2-4. The systems and methods described herein can be used to improve efficiency of fuel systems.

Referring to FIG. 1, an aircraft fuel system 100 includes a first pump system 101 that is mechanically driven (e.g., via a gearbox 103 connected to an input shaft from an engine). The first pump system 101 is in selective fluid communication with a fuel tank 105 and one or more fuel nozzles 109 of an engine. The first pump system 101 is configured to pump fuel to the fuel nozzle 109 in a high flow rate condition (e.g., take-off, climb) and to be starved or nearly starved of fuel in a low flow rate condition (e.g., cruise, descent, start-up). The first pump system 101 can include a first pump 107 (e.g., a take-off pump configured to supply suitable flow during take-off or other high fuel flow conditions) and/or any other suitable pumps.

The aircraft fuel system 100 also includes a second pump system 111 that has an electric motor 113. The second pump system 111 is in fluid communication with the fuel tank 105 and the fuel nozzle 109 to pump fuel from the fuel tank 105 to the fuel nozzle 109. The second pump system 111 is driven by the electric motor 113 and is configured to pump flow in both the high flow rate condition (e.g., take-off, climb) and the low flow rate condition (e.g., cruise, descent, start-up).

In certain embodiments, the second pump system 111 can include a total-flow pump 115 and a main pump 117 attached to the electric motor 113. The total-flow pump 115 can be configured to boost the main pump 117 and/or the mechanically driven first pump system 101, for example.

The system 100 can include a first valve 118 configured to shut-off or otherwise limit fuel flow to the first pump system 101. The first valve 118 can be positioned between the total-flow pump 115 and the first pump system 101, for example, or in any other suitable location.

The system 100 can include a heat exchanger 119 disposed between the first pump system 101 and the second pump system 111. The heat exchanger 119 can be a fuel-oil heat exchanger, for example, that is configured to cool engine oil with the fuel in the fuel system 100. Any other suitable heat exchanger type is contemplated herein. The heat exchanger 119 can be placed downstream of the second pump system 111. This ensures there is always fuel flow through the heat exchanger regardless of the selected flight phase and pump(s) operation mode. The heat exchanger 119 and/or any suitable additional heat exchanger(s) can be placed in any other suitable location(s).

In certain embodiments, the system 100 can include an ejector pump 121 disposed between the first pump system 101 and the total flow pump 115 of second pump system 111. The ejector pump 121 can be configured to evacuate the first pump system 101 in the low fuel flow condition so as to reduce power consumption. The ejector pump 121 can include a venturi, for example.

In certain embodiments, the system 100 can include a system shut-off valve 123 disposed upstream of the fuel nozzle 109 and downstream of the first and second pump systems 101, 111. System shut-off valve 123 can shut down the engine by preventing fuel flow to the fuel nozzle 109. The valve 123 can prevent any accidental fuel dripping into the fuel nozzles 109.

The system 100 can include a throttle valve 125 disposed between the first pump system 101 and the fuel nozzle 109 in certain embodiments. The throttle valve 125 can include feedback systems for control. Any other suitable valves (e.g., check valves 127) can be included as is appreciated by those having ordinary skill in the art in view of this disclosure. The throttle valve 125 can be placed upstream of the check valve 127. This provides ability to limit the first pump system 101 with the throttle valve 125 and to close it or otherwise limit it with the first valve 118.

The system 100 can include a controller 129 (e.g., an EEC, FADEC, any other distributed control architecture for example) operatively connected to the electric motor 113 and to one or more sensors disposed in the fuel system to control the electric motor as a function of output of the one or more sensors. The controller 129 can be operatively connected to one or more suitable valves (e.g., as described above) to actuate the valves as a function of the output of the one or more sensors. In certain embodiments, the one or more sensors can include at least one of a flow meter 131 disposed upstream of the fuel nozzle 109, a pressure sensor 133 disposed downstream of the first pump system 101, or a second pressure sensor 135 disposed downstream of the fuel nozzles 109.

In certain embodiments, a pressure sensor 133 can be placed directly upstream of throttle valve 125. The second pressure sensor 135 which can sense burner pressure of the combustor (not shown) can be placed downstream of the fuel nozzles 109. The first and second pressure sensors 133, 135, as well as the throttle valve 125, can be operatively connected to and/or controlled by the controller 129 to provide accurate feedback for active control of the fuel flow meter 131 in real time. This can ensure optimum engine TSFC during all flight phases of the aircraft.

The main pump 117 can include one of a vane pump or gear pump, or any other suitable pump. The total-flow pump 115 and/or the take-off pump 107 can include a centrifugal pump, in certain embodiments.

Referring to FIG. 2, the system 100 is shown in a low fuel flow condition (e.g., cruise, start-up, descent). Notionally, the direction of fuel flow is shown with white arrows. As shown, the first valve 118 is closed, preventing fuel from traveling to the first pump system 101. The first pump system 101 is evacuated of fuel by the ejector valve 121, thereby reducing wear on the pump 107 by reducing power and heat load. This pump 107 may continue to rotate (e.g., if it is connected rigidly to the gearbox 103 shaft) however it is not pumping any liquid fuel and the pump load is minimal. Fuel is still allowed to flow from the second pump system 111 (e.g., at a rate controlled by the speed of the electric motor 113, for example, as a function of sensor readings).

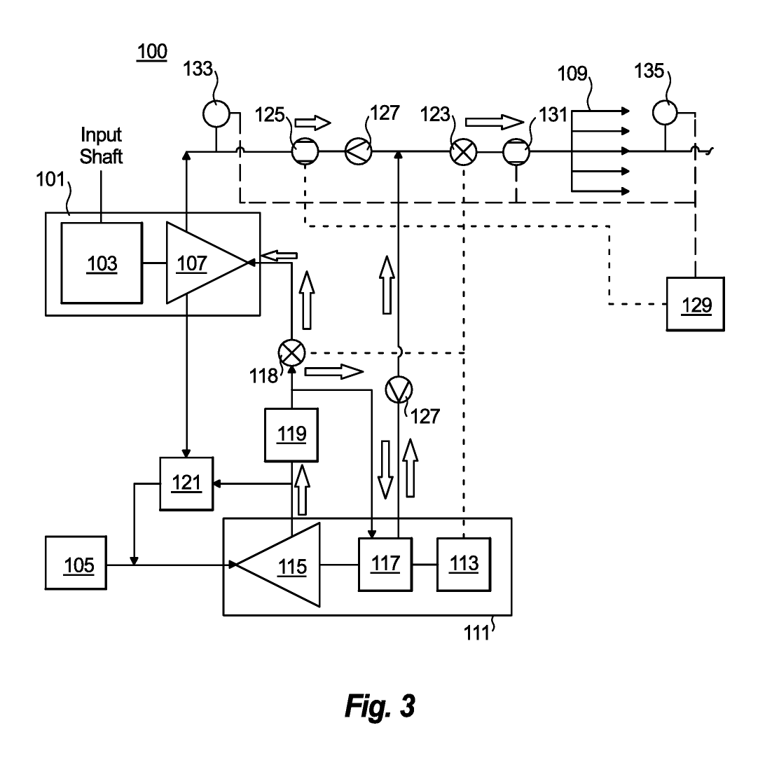

Referring to FIG. 3, the system 100 is shown in a high fuel flow condition (e.g., take-off). Notionally, the direction of fuel flow is shown with white arrows. As shown, the first valve 118 is open and allowing fuel from the tank 105 to the mechanically driven pump system 101 (e.g., which is boosted by the total-flow pump 115). Fuel is also pumping from the electric motor-driven second pump system 111. In this regard, maximum fuel is being supplied to the engine for high power scenarios (e.g., take-off). The electric vane/gear main pump 117 is sized to provide a maximum fuel flow (e.g., 3000 pph, 150 psia for example) at 100% pump rotational speed. The combined output of all the fuel pumps ensures sufficient fuel flow and fuel pressure is provided to the fuel nozzles 109 of the engine during the take-off phase of the flight. This configuration may be re-activated during transient high-fuel-flow settings (e.g. step climb, acceleration, etc.) as needed.

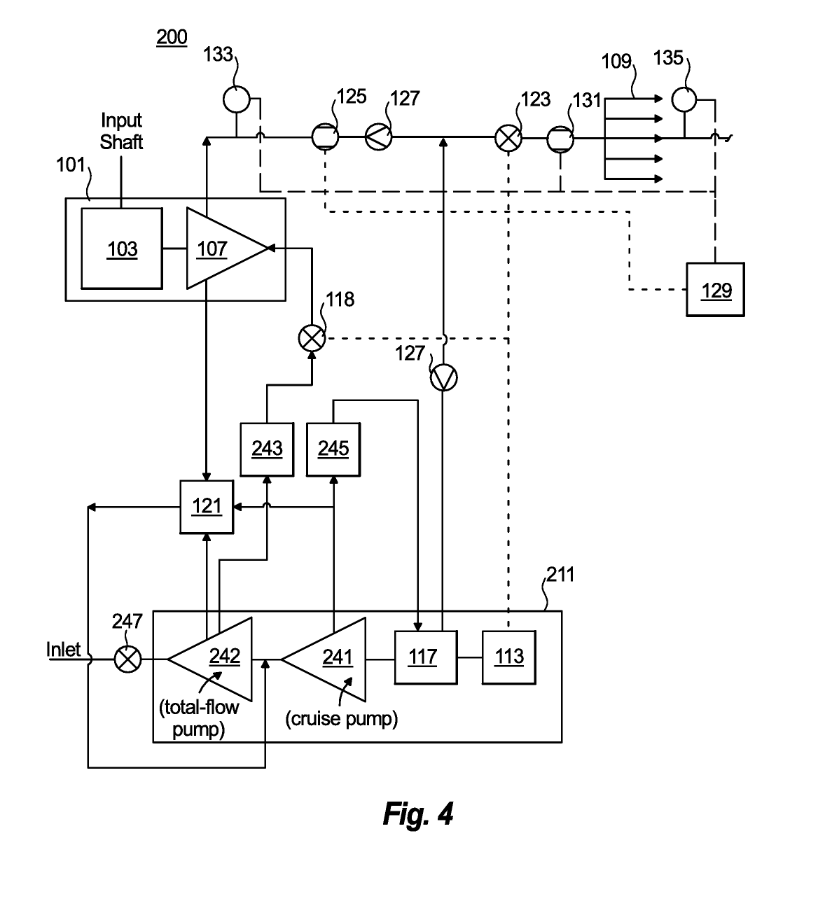

Referring to FIG. 4, another embodiment of a fuel system 200 is shown. The second pump system 211 can additionally include a cruise pump 241 that is configured to boost the main pump 117 and is sized for fuel demands in a cruise flight condition. The total-flow pump 242 can be sized for a high fuel flow condition in such an embodiment, for example. The cruise pump 241 can include a centrifugal pump, in certain embodiments.

In certain embodiments, the system 200 can include a first heat exchanger 243 disposed between the total-flow pump 242 and the first pump system 101 and a second heat exchanger 245 disposed between the cruise pump 241 and the main pump 117. The heat exchangers 243, 245 can be any suitable heat exchanger as described above, for example. The system 200 can include a system shut-off valve 247 disposed upstream of the first and second pump systems 101, 211.

The system 200 can operate similarly to system 100 as described above. The system 200 includes additional pumping hardware and modified flow circuitry to provide additional pump pressure in the event of failure of the mechanically driven pump system 101 and/or allow additional fuel flow as needed. As shown, the total-flow pump 242 can evacuate the fuel flow during cruise flight conditions, e.g., in a more efficient way. When it is needed, the total-flow pump 242 is filled with fuel and provides fuel flow to the gearbox-driven take-off pump 107.

In certain embodiments, total-flow pump 242 can also be mounted on the output shaft form the electric motor 113. In certain embodiments, this pump 242 can be alternately mounted on a mechanical drive elsewhere and be driven by a mechanical pad rather than the motor. The gearbox driven take-off pump 107 can be multistage to improve specific speed and overall efficiency.

As described above, output of the gearbox-driven fuel pump 107 can flow through a throttle valve 125, a check valve 127, and can be eventually delivered to the fuel nozzles 109 of the engine. A fuel flow meter 131 can be placed downstream of check valve 127 and upstream of the fuel nozzles 109. This can be used to calibrate the fuel flow vs. speed for the main pump 117 as well as the throttle valve 125 position vs. fuel flow speed for the gearbox-driven centrifugal take-off pump 107.

A fuel pressure sensor 133 can be placed directly upstream of throttle valve 125. A second pressure sensor 135 can be used to sense burner pressure of the combustor by being placed downstream of the fuel nozzles 109. These sensors and the throttle valve 125 can be controlled by the controller 129 (e.g., an EEC/FADEC) to provide accurate feedback for active control of the fuel flow meter 131 in real time. This ensures optimum engine TSFC during all flight phases.

Embodiments allow metered fuel flow to be delivered to the fuel nozzles 109 based on the exact fuel demand set by the engine power settings (e.g., detected by the burner pressure sensor 135) as function of electric motor 113 speed (e.g., continuously variable) of the main fuel pump 117. Embodiments can closely match the engine power settings and fuel demand with the fuel supply form the various fuel pumps. This optimizes the operation of the fuel pumps, thus extending their operational life (lower wear, heating, etc.). As a consequence, the overall fuel thermal management is improved (less/minimal fuel recirculation), while fuel remains a viable cooling sink due to its lower service temperature. This in turn, requires smaller/lighter/more compact heat exchangers which also saves weight.

Embodiments as described above eliminate wasteful fuel re-circulation during lower engine power settings, shuts off fuel flow to gearbox-driven pumps when not needed, lower power demand to drive fuel pumps, lower operational speed of fuel pumps, and allows all pumps to be controlled in real-time by a controller (e.g., the engine's EEC/FADEC for example).

The methods and systems of the present disclosure, as described above and shown in the drawings, provide for aircraft fuel systems with superior properties. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. An aircraft fuel system, comprising:
a first pump system that is mechanically driven and in selective fluid communication with a fuel tank and one or more fuel nozzles of an engine, the first pump system being configured to pump fuel to the one or more fuel nozzles in a high flow rate condition and to be starved or nearly starved of fuel in a low flow rate condition; and
a second pump system including an electric motor, the second pump system in fluid communication with the fuel tank and the one or more fuel nozzles configured to pump fuel from the fuel tank to the one or more fuel nozzles, the second pump system being driven by the electric motor and being configured to pump flow in both the high flow rate condition and the low flow rate condition.

2. The aircraft fuel system of claim 1, wherein the second pump system includes a total-flow pump and a main pump attached to the electric motor, wherein the total-flow pump is configured to boost the main pump and/or the mechanically driven first pump system.

3. The aircraft fuel system of claim 2, further comprising a first valve configured to shut-off or otherwise limit fuel flow to the first pump system, the first valve positioned between the total-flow pump and the first pump system.

4. The aircraft fuel system of claim 1, further comprising a heat exchanger disposed between the first pump system and the second pump system downstream of total flow pump of second pump system.

5. The aircraft fuel system of claim 1, further comprising an ejector pump disposed between the first pump system and the total flow pump of second pump system and configured to evacuate the first pump system in the low fuel flow condition.

6. The aircraft fuel system of claim 5, wherein the ejector pump includes a venturi.

7. The aircraft fuel system of claim 1, further comprising a system shut-off valve disposed upstream of the fuel nozzles and downstream of the first and second pump systems.

8. The aircraft fuel system of claim 1, further comprising a throttle valve disposed between the first pump system and the fuel nozzles.

9. The aircraft fuel system of claim 1, further comprising a controller operatively connected to the electric motor and to one or more sensors disposed in the fuel system to control the electric motor as a function of output of the one or more sensors.

10. The aircraft fuel system of claim 9, wherein the controller is operatively connected to one or more valves of the aircraft fuel system to actuate the valves as a function of the output of the one or more sensors

11. The aircraft fuel system of claim 9, wherein the one or more sensors include at least one of a flow meter disposed upstream of the fuel nozzles, a pressure sensor disposed downstream of the first pump system, and a pressure sensor disposed downstream of the fuel nozzles.

12. The aircraft fuel system of claim 2, wherein the main pump includes one of a vane pump or gear pump.

13. The aircraft fuel system of claim 2, wherein the second pump system includes a cruise pump, wherein the cruise pump is configured to boost the main pump.

14. The aircraft fuel system of claim 13, wherein the first pump system includes a take-off pump.

15. The aircraft fuel system of claim 14, wherein the total-flow pump, the cruise pump, or the take-off pump includes a centrifugal pump.

16. The aircraft fuel system of claim 13, further comprising a first heat exchanger disposed between the total-flow pump and the first pump system and a second heat exchanger disposed between the cruise pump and the main pump.

17. The aircraft fuel system of claim 1, further comprising a system shut-off valve disposed upstream of the first and second pump systems.

18. A method, comprising:
adjusting volume of fuel pumped to one or more fuel nozzles in response to a change in fuel demand of an engine.
